(19) United States
(12) Patent Application Publication
(10) Pub. No.: US 2003/0214481 A1
(43) Pub. Date: Nov. 20, 2003

(54) Finger worn and operated input device and method of use

(76) Inventor: Yongming Xiong, Fremont, CA (US)

Correspondence Address: Mr. Yongming Xiong, 43133 Gallesgos Avenue, Fremont, CA, 94539, US

(21) Appl. No.: 10/146,572

(22) Filed: May 14, 2002

(51) Int. Cl. G09G 5/08

(52) U.S. Cl. 345/157

(57) ABSTRACT

The present invention provides a finger worn and finger operated input device for personal computer, workstation or computer based instrumentation. The finger operated method in the present invention eliminated the necessary of a stationary support table or pad. The special operation method of the device also eliminated the affect from tremor and movement of user's hand. Therefore user can operate the device at any comfortable posture. A method for dynamically adjusting the mapping sensitivity from the device to cursor movement based on the touch pressure between the fingertips ensures that user can achieve large and small cursor movement on the same small sensor area. user can friendly operates the said device with natural finger movement and gestures to help minimize strain on neck, shoulder, hand and wrist muscles, thereby alleviating the possibility of Repetitive Strain Injury (RSI) and Carpal Tunnel Syndrome (CTS) which normally associated with desktop mouse devices. The present invention further provide ergonomic peripheral input system for computer by in conjunction use with a virtual keyboard on computer screen. The present invention also has advantage in other special applications such as for projection presentations.

### SEQUENCE LISTING OR PROGRAM

Not Applicable

### FEDERALLY SPONSORED RESEARCH

Not Applicable

### BACKGROUND

1. Field of Invention

The present invention relates to a finger worn and operated computer input device and method of use, more particularly, a device and method of use for controlling the positioning, movement and operation of a viewpoint or cursor on a display screen associated with a computer.

2. Description of Prior Art

Users of a computer typically enter input using either a keyboard or a pointing device. Prior art pointing devices for positioning a cursor and entering commands into a computer are well known such as mouse, trackball, touch pad, pen stylus, and the like.

The mouse typically includes: (1) a housing or top portion upon which the user's hand rests (2) two or three keys integral with the housing which can be depressed for supplying additional signals to the computer for selecting choices from a displayed menu (3) a bottom portion or base which contains a pair of motion transducers and electronics to detect the movement of the mouse on a support surface in two orthogonal directions. A mouse controller reads the state of those sensors and takes account of current mouse position. The mouse controller sends a packet of data to the computer data interface controller causes a position indicator (cursor) on a video display connected to the computer to move in relatively the same direction and magnitude.

There are two basic types of mouse: mechanical and optical. Mechanical mice employ a rotatable ball which contacted with two orthogonal aligned axles with little photo-interrupter wheel connected respectively, wherein electronic encoders sense rotation of the ball and generate a signal indicative of the ball's rotation. The rotatable ball extends from the bottom surface of the mice, and contacts a work surface such as a table or mouse pad. The movement of the mice across the work surface causes rotation of the ball and therefore wheel turning. The electronic encoders sense how fast the ball is moving in X and Y directions. Optical mice consist of no ball on the bottom. Instead, there is a camera. But the way for user to operate is the same.

A trackball is like a mouse turned upside down. The body of the trackball sits still. It moves by the user's fingers. It works in the same way as a mouse, with the ball turning rollers, the rollers turning axles, which are in turn connected to either mechanical or optical sensors that measure their rotation.

A small joystick usually found at a central position on portable laptop computers keyboard. The button-like joystick, also known as a pointing stick, is pressure-actuated pointing devices include strain gauges or transducers that detect the direction and magnitude of the force of the user's finger on the device. One source of trouble is inertia, whereby the pointer continues to move after the user releases the pressure on the device. Another trouble is tremor causes involuntary changes in the velocity at which the cursor moves. So the joystick is difficult for users to achieve fine cursor control and making it difficult to stop the cursor at a desired point on the screen. In order to select items on the display screen, upwardly extending “mouse” or “click” buttons must be provided somewhere on the computer.

Touchpads are pointing devices used for inputting coordinate data to computers and computer-controlled devices. A touchpad may be integrated within a computer or be a separate portable unit connected to a computer like a mouse. When a user touches the touchpad with a finger, stylus, or the like, the circuitry associated with the touchpad determines and reports to the attached computer the coordinates or the position of the location touched. Touchpads can be used as the same function as a mouse for computer cursor control. Several types of touchpads are known in the art such as capacitive, resistive and force sensing touchpads. Occasionally, the user will want to move the cursor across a large screen distance, for example, from one side of the display to another. This may need finger to travel on the touchpad several times from one side to the other side. Comparing to the mouse's moving speed, Finger's moving speed normally slower than that of mouse.

Keyboard mainly used as another important computer input device. It requires the operator to sit down in front of the keyboard and two hands have to always lift for typing. Hours typing with confining position may cause operator feel fatigue and stress.

All these prior art point devices need to be support solidly on a flat support pad or table. Secondly most of them are large in size. So they does not fit well in a volume-sensitive application and for small confined area or mobile environment where there is insufficient room. The keyboard and pointing device such as mouse or joystick devices with relatively fixed position in close proximity to the host system. Users have to sit very close to a table on which all the computer input devices sit. User has to lift a hand from the keyboard to make the cursor movement, thereby upsetting typing on the computer; User has to lift his arm and twist his forearm to put the palm of his hand in a horizontal position over the point device. User must reach out to use it during typing. This action can cause enormous stress on the neck, arm and shoulder. All these designs have no enough consideration for natural method operation with modality. Prolonged use of these prior art point devices can cause bio-mechanical stress to the user. For example, the hand or arm of the user may feel tired or cramped after grasping and operating these pointing devices for any length of time. More seriously, repetitive stress injury (RSI), a cumulative trauma disorder stemming from prolonged repetitive, forceful, or awkward hand movements, may be experienced, with its' resultant damage to the muscles, tendons, and nerves of the neck, shoulder, forearm, and hand.

As electronic computing, process control and communication devices become increasingly integrated into daily routine, more flexible interface device is sought. Wireless point and input devices offer limited improvement of the operation flexibility. But long term effects including repetitive motion syndrome, user fatigue, muscular tension or other discomfort still exist because non-ergonomically designed devices and non-ergonomic operation.

The present invention discloses a finger worn and operated input device, which can be worn on finger anytime and be used flexibly on various situations. User can friendly operates the said device with natural finger movement and gestures. User's hands and eyes never have to leave the keyboard or screen. The ergonomically and natural comfortable motions used in operating the finger worn and operated input device help minimize strain on neck, shoulder, hand and wrist muscles, thereby alleviating the possibility of Repetitive Strain Injury (RSI) and Carpal Tunnel Syndrome (CTS), normally associated with desktop mouse devices. Works equally well on right or left hand.

### SUMMARY OF THE INVENTION

Accordingly, the primary object of the invention is to provide an efficient and unobstructive input device for sensing natural gesture and movement between fingers without restricting operator location or orientation. to detect cursor pointing and command input, and transmit via wireless link corresponding electronic signals.

A more specific object of the invention is to provide an ergonomic input device operated by natural gesture and movement between thumb tip and index fingertip or middle fingertip with minimal obstruction of the hands. Also to allow the operator to multiplex computer interface with other activities, allowing flexibility of operator position and orientation. Operator fatigue and the detrimental effects associated with disorders such as Carpal Tunnel Syndrome and Repetitive Stress Injury is mitigated.

Another object of the invention is to provide a finger worn and operated point device which do not need any stationary support. So it fit well in a volume-sensitive application and for small confined area or mobile environment where there is insufficient room.

Another object of the invention is to provide a totally ergonomic and spacing saving input system for Graphic User Interface (GUI) application like internet browser by using the wireless finger worn and operated input device in conjunction with an virtual keyboard displayed on screen which operated by the said input device. So computer user can operate the computer by any arbitrary and more relax posture, sit down or stand up, hand lift or down, left hand or right hand or even in pocket. Typing fatigue and stress can be alleviates and chance of repetitive stress injury can be reduced.

Another object of the invention is to provide, with a minimum of intrusion to other activities, an ergonomic method and apparatus for simultaneous typing, cursor pointing, to a computer. A finger worn and operated device results from the ability to switch quickly between cursor movement, pointing and typing, therefore increase the typing productivity for text input application if the point device in the invention used with traditional keyboard because the hands can always keep above the keyboard area.

Yet another object of the invention is to provide projector presenter a flexible way to operate the slide by himself during walk around near the projector, laptop and large screen. The device in the invention is also a good substitution for handheld laser pointing device to increase the accuracy of the pointing and eliminate the laser spot shaking.

Other objects and advantages of the present invention will become apparent from the following descriptions, taken in connection with the accompanying drawings, wherein, by way of illustration and example, an embodiment of the present invention is disclosed.

A wireless finger operate input device in the invention comprising two portions. The first portion is the finger worn unit which includes a miniature XYZ three dimension position sensor or XY two dimension position sensor in conjunction with another pressure sensor and electronics such as sensor signal processing circuit or micro-controller (MCU), radio frequency (RF) transmitter, antenna and battery, a thimble dimensioned and electrical insulate housing for finger engagement and for the sensor mounting and elastic finger wear band and Velcro strap. The second portion includes the radio frequency receiver, Microcontroller and interface circuit for computer serial port or mouse port interface.

These and other features, aspects, and embodiments of the present invention will become better understood with regard to the following description, appended claims, and accompanying drawings. The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective view of finger worn and operated input device according to the present invention in use with a personal computer.

FIG. 2A is a block level schematic diagram of preferred embodiment of the finger worn and operated input device of the present invention.

FIG. 2B is a block level schematic diagram of the computer receiving adapter unit of the finger worn and operated input device of the present invention.

FIG. 3A is the algorithm flow diagram for dynamically adjusting the mapping sensitivity from the relative fingertip movement to cursor movement.

FIG. 3B is an illustration of finger tapping gestures.

### DETAILED DESCRIPTION OF THE PREFERRED EMBODIMENTS

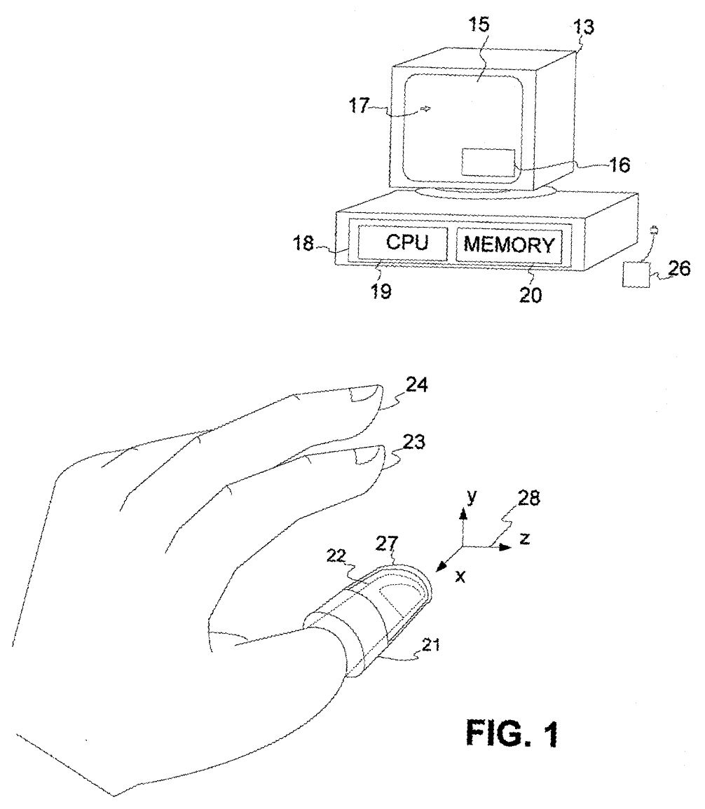

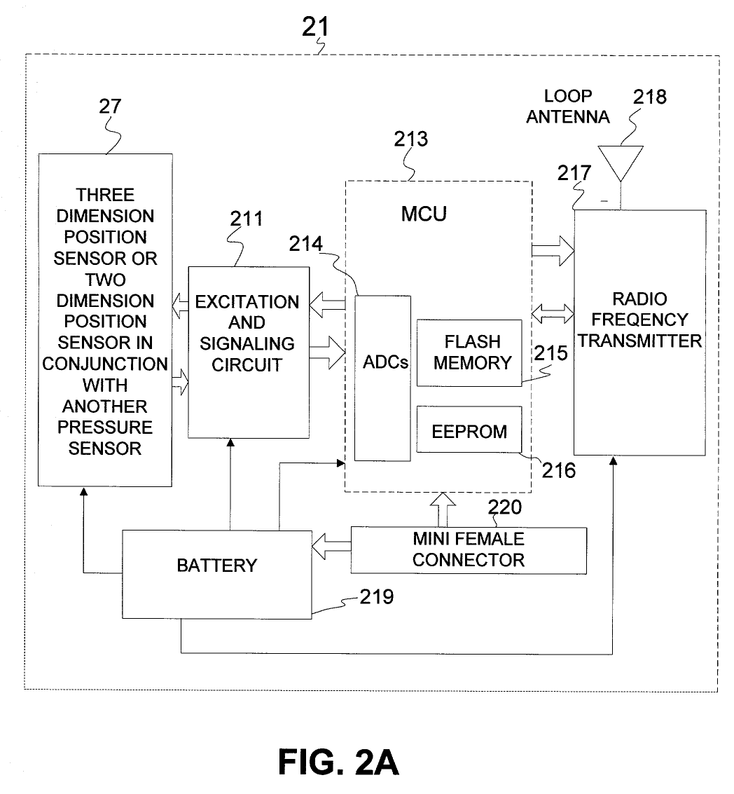

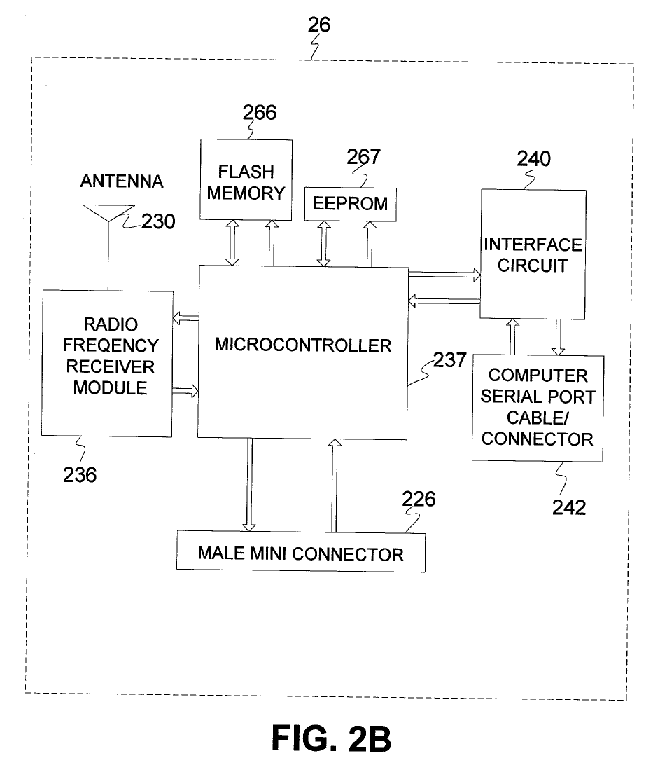

Referring to FIG. 1 is a perspective view of the finger worn and operated input device according to the present invention interactive with a personal computer which includes a display 13 with a screen 15, a small virtual keyboard 16 displayed on screen 15. A pointer 17 is shown displayed on screen 15. Display 13 may be, for example, a standard CRT computer monitor. Alternatively, screen 13 may operate on any of several non-CRT technologies used in laptop and notebook computers. The computer also includes a processor 18 that includes a central processing unit (CPU) 19 and random access memory (RAM) 20. User operates the computer with the finger worn and operated input device 21 wearing on thumb 22. As will be described in detail hereinafter in FIG. 2A and FIG. 2B. The communication from input device 21 to the computer mouse port or serial port directly through cable, or preferably, by wireless technology such as infrared wireless or RF wireless technology. The preferable communication form for the present invention is a so-called short-range radio frequency (RF) technology which give the device 21 maximum operating flexibility. The advantage of direct cable connection is less components and less cost since battery, wireless transmitting and receiving components can be eliminated while the user's operation flexibility is limited to some extent. Infrared wireless implementation gives the operating flexibility and cost between that of RF and cable communication forms. Finger worn and operated input device 21 includes sensor 27, which is a three dimension position sensor or two dimension sensor and another pressure sensor, a thimble dimensioned electrical isolation base for finger such as thumb 22 to wear, attached to it are a solid base for the sensor 27 to mount rigidly and a house wherein all the electronic components such as sensor signal processing circuit or micro-controller, radio frequency (RF) transmitter, antenna, battery located, an elastic finger wear band or Velcro strap to secure thumb 22 with device 21. The sensor 27 is securely worn on the thumb 22 and coincident with the thumb tip. It moves exactly the same way when the thumb tip is moving. The operator curls index finger 23 or middle finger 24 to thumb 22 so the two fingertips touch together. Despite of hand tremor or movement, one can easily control the two contacted fingertips with and without any relative movement even his hand is moving, shaking and at any posture. This is why the Finger worn and operated input device in the present invention do not need any stationary support surface to operate. So refer to the relative movement between circled fingers, the thumb worn sensor acts like supported by solid stationary table. Quick movement can be achieved since the curled two fingertips can move in opposite direction each other and simultaneously.

The XYZ coordination systems 28 is on the thumb 22. XYZ is the three dimension coordination. XY planar refer to the planar parallel with the tip of thumb 22. X refer to the thumb pointing direction. Z refer to the direction vertical to XY planar or tip of thumb 22. Z particularly refer to the pressure between the fingertip and thumb tip. Three dimension vector [x, y, z] represent the fingertip touch position and heaviness on the tip of thumb 22 or sensor surface since it is securely worn on the thumb 22 and parallel with the thumb tip.

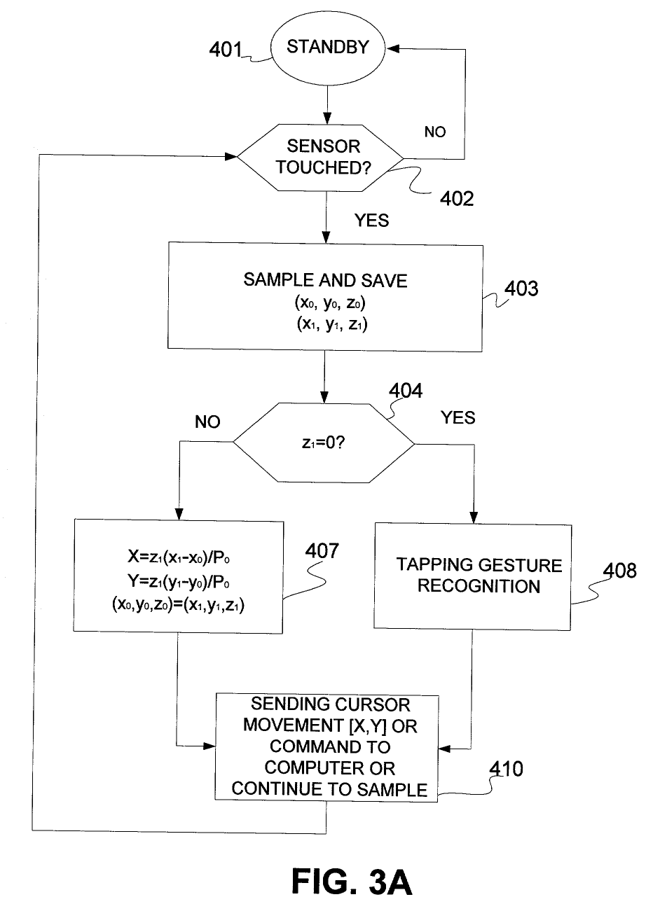

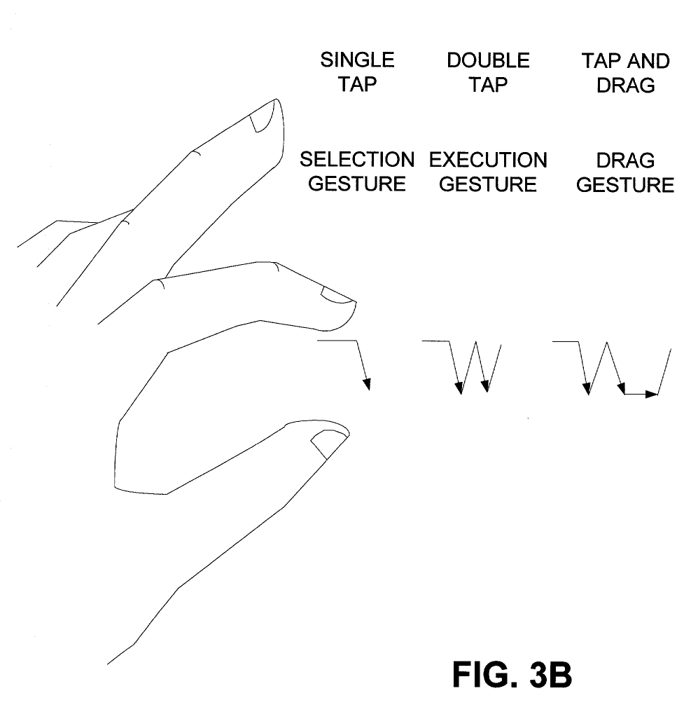

When the fingertip of curled index finger 23 or middle finger 24 moves or taps on the sensor which covers the tip area of thumb 22. The three dimension position sensor 27 sensing the relative displacement in XY coordination and pressure at every [x, y] location. The processing circuit and Microcontroller in the finger worn and operated input device 21 digitized those sensing signals, wherein the cursor movement vector calculated based on the first touch heaviness z and the algorithm illustrated in FIG. 3A. The cursor movement vectors are optionally transmitted to receiving unit 26 connected to the computer mouse port or serial port by cable or wireless, where they are passed onto the computer. thereby causing computer to control the cursor 17 movement or response to the command signals.

After the cursor 17 is appropriately positioned, the control buttons, sometimes referred to as keys or switches, permit the user to enter various commands into the computer. For example, quick double tap the fingertips may invoke an application program. Single tapping the fingertips highlight text. While pressing down the control button to select an object on the screen and moving the point device will drag the object from it's original location to some where else etc.

A small virtual keyboard 16 may always displays on the corner of screen 13 or it can be a virtual keyboard icon displayed on the screen 13 and it can be invoked to a virtual keyboard by cursor 17 pointing to the icon and double clicking it. Virtual keyboard 16 may be used for the application without frequently text typing. Double click the key button on the virtual keyboard 16, Processor 18 can tell which text input from the virtual keyboard application software.

The finger worn and operated input device of the present invention may be used with an index finger stall with a small stylus. In comparison with fingertip touching, finger stall stylus usage provide more large equivalent sensing area, provide more high resolution while shorten the sensor recover time and MCU computing time so more fast sample rate can be achieved.

The preferred main components include sensor, MCU and RF transmitter should be low power consumption, small in size to ensure the input device can be worn on the finger comfortably, to ensure long operating time for battery. The preferable antenna will be small in size with moderate efficiency. Chip antenna is very small in size advantage while maintaining efficiency, but bandwidth reduced and is easily detuned by hand effects. PCB loop antenna is very inexpensive. It can be hidden inside the housing and still be rather efficient. Another advantage of the loop antenna is it is not detuned easily by hand effects.

Miniature position sensor and pressure sensor is the key component in the finger worn and operated input device. As long as the sensor is thin, small in size and with low power consumption, a wide range of two dimension sensor can be selected to sensing fingertip displacement in XY coordination plane. Such as joystick, fingerprint sensor, grid capacitor sensor. Two or three mini press buttons may be needed to fully implement the whole mouse function if joystick sensor is used in conjunction with another pressure sensor. The preferred sensor configuration is the XY two dimension displacement sensor with additional function to sensing the finger touch pressure. U.S. Pat. No. 6,239,790B1 disclosed a force sensing semiconductive touchpad assembly and method for providing a signal to a computer indicative of the location and applied pressure of an object touching the touchpad assembly. The touchpad assembly includes X and Y position and pressure sensitive semiconductor resistance sensor layers. The X and Y sensors have a pair of spaced apart X and Y conductive traces running across opposite ends such that a resistance RX connects the pair of X traces and a resistance RY connects the pair of Y traces. The X and Y sensors come into contact at a contact point when an object asserts a pressure on the touchpad. The contact point is connected to each trace by a variable pressure resistance RZ associated with the X and Y sensors and variable position resistances of the X and Y resistances. First and second pair of timing capacitors are connected to respective ones of the pairs of X and Y traces. A microprocessor controls and monitors charging time of the capacitors to determine the position and asserted pressure of the object touching the touchpad. The sensor has 0.001 inch resolution. Sensing area can be build smaller than 25.5 mm×25.5 mm with thickness less than 6 mm. The high resolution and small sensing area FSR sensor is very suitable for thumb worn and coincident with thumb pad.

Alternatively, if the three dimension sensor is the two dimension sensor joystick in conjunction with an other pressure sensor, Two or three mini press buttons may be needed to fully implement the whole mouse function. Also the pressure sensor signal provides two functions, The first is to act as a parameter to dynamically adjust the mapping sensitivity from touched fingertips of thumb 22 and index finger 23. The second function is used to validate the joystick output signal. Joystick output signal to be considered valid only when pressure sensor has output. This can eliminate the inertial effect of joystick and interference.

Referring to FIG. 2A is a block level schematic diagram of the finger worn and operated input device 21 of the present invention. The finger worn and operated input device 21 according to the present invention, as shown in FIG. 2A, comprises sensor 27 which is a three dimension position sensor or two dimension sensor in conjunction with a another pressure sensor, sensor signaling excitation circuit 211, sensor signaling circuit 212, highly integrated Microcontroller(MCU) 213 contains internal Flash memory 215, analog to digital converters (ADCs)214 and internal EEPROM 216, for example be a low power version of a Atmel AT90LS4433, radio frequency (RF) transmitter 217, loop antenna 218 and battery 219. Optionally mini switch buttons (not shown) can be added for click functions. Female connector 220 has connection to battery 219 and MCU 213. Battery 219 provides DC power to all the electrical components in the device 21. When device 21 plugged on a male connector on receiving unit 26 by connector 220, input device 21 will receive power from receiving unit 26 and battery 219 will be recharged.

The RF transmitter 217 is a single chip RF transmitter, highly integrated circuit with internal frequency synthesizer consists of a crystal oscillator, phase detector, charge pump, voltage controlled oscillator, and frequency dividers. An external crystal may be needed for the RF transmitter 217. RF transmitter 217 also consists internal RF low noise amplifier and programmable RF power amplifier.

On power up of the mouse (insertion of batteries), MCU 213 receive the information includes the frequency of the current radio channel, the sampling rate of the position sensor 27, pressure sensitivity parameter, transmitter power level and the identification code information for that particular mouse from internal non-volatile Flash memory 215 or EEPROM 216. In an exemplary embodiment, the identification code information could be a 8 bits address code with 255 possible different combinations and allows a computer receiving unit 26 to differentiate between two RF wireless input devices operating on the same transmission frequency and in the same transmission zone, so that each device 21 has a single identification number that will be accepted by its corresponding computer receiving unit 26.

In the preferred embodiment, An application software can be run in computer and user can input and download the configuration information to the computer receiving unit 26 and finger worn and operated input device 21. The computer receiving unit 26 receives the downloading configure information directly from computer mouse port or serial port. The finger worn and operated device 21 accept the same configure information by plug finger worn and operated input device 21 to the computer receiving unit 26.

The position and pressure of touched index fingertip and thumb sensed by the three dimension position sensor 27 in form of three dimension vector [x, y, z], [x,y] refer to the fingertip touch position in xy coordinate system, z refer to the touch heaviness in the direction vertical to the sensor surface. [x, y, z] quantized by analog to digital converter(ADC) 214 and sampled by MCU 213 in accordance with the clock signal provided by a clock generator which, in the preferred embodiment, is internal to the MCU 213. The MCU 213 calculates the input signals based on the three dimension vector [x(t),y(t),z(t)] and algorithm further detailed illustrated in FIG. 3A. The MCU 213 provides the calculated switch and displacement information in predefined protocol and packets format to the frequency shift keying (“FSK”) modulator of the RF transmitter 217 by serial interface. The RF output is frequency shift keyed (FSK) by the digital bit stream fed to the digital signal input pin. The information to be transmitted is then provided to a voltage controlled oscillator VCO) inside the RF transmitter 217 which in turn provides the modulated carrier signal to a loop antenna 218 through an RF amplifier. The transmitted signals then are picked up by a receiver in the receiving unit 26, discussed in greater detail hereinafter. CPU 19 receives the displacement signal from computer receiving unit 26 to control the X-Y position of pointer 17 on screen 15. As will further be described in detail hereinafter, sensor also senses the placing or lifting of a finger on sensing area or changes in finger pressure on sensing area to provide Z input to MCU 213. Z input is primary used to scale mapping sensitivity from the fingertips relative movement to cursor movement on screen 15 in the present invention. Significant Z input variation may be interpreted as mouse button up and mouse button down signals.

Power of the system is preferably provided by a battery 219. Preferably, rechargeable coin type battery with enough capacity will be used. If desired, a low voltage detector may be provided to signal low battery conditions to the user. The device 21 will typically not turn off, but instead can operate in three power modes (normal, standby and power down) to conserve energy. In normal operation, such as when the device is being touched, the sensor output signals [x, y, z] will be sampled at full speed, the MCU 213 is run at its nominal speed, and displacement and button data is sent continuously to the computer receiving unit 26. However, If no action is detected for a first period, the device 21 will enter a standby mode during which the sensor outputs [x, y, z] are sampled less frequently, although the MCU stops its MCU while allowing peripheral I/O including ADC still functioning. Meanwhile, MCU 213 also set the RF transmitter 217 to stand by mode. However, to further conserve power in standby mode, the MCU 213 power down the RF transmitter 217 and it's internal oscillator. The MCU 213 saves the RAM content, freezes its own oscillator, disabling all the chip function until any activity (i.e. fingertip movement or taps on the device sensor) does occur to power up the rest of the circuitry)

FIG. 2B shows in schematic block diagram of the computer RF wireless receiving unit 26. Similar to the input device 21, the receiving unit 26 includes an antenna 230, a RF receiver module 236, MCU 237 with flash memory 266 and EEPROM 267, signal translator 240 for MCU CMOS signal to computer serial interface (i.e. RS232, UBS etc.), Computer serial port connector 242 and male mini connector 226. Receiving unit 26 may receive power from AC to DC module (not shown) or directly from computer mouse port or series port. Receiving unit 26 receiving the signal from finger worn and operated device unit 21 and pass to processor 18. The mini connector 226 for computer port connection with or without cable. Mini connector 226 is for finger worn and operated device 21 to plug for battery charge and configuration.

The RF receiver 236 module consists of a crystal oscillator, phase detector, charge pump, voltage controlled oscillator, frequency dividers, RF low noise amplifier and programmable RF power amplifier.

Unlike the MCU inside device 21, MCU 237 does not need A/D converter function. The Flash memory and EEPROM 260 can be either internal or external to MCU. It only need to support 2 or3 wire I/O port to configure the RF receiver and read RF receiver output signals which is transmitted from device 21, then send the cursor movement and command signal to the serial port interface circuit 240 which communicate to the computer. The EEPROM memory 260 stores the information such as the frequency of the current radio channel, the sampling rate of the position sensor 27, pressure sensitivity parameter, transmitter power level and the identification code information for that particular mouse from the configuration application and during configuration stage. Flash memory 260 also provides information to the MCU 237 at power up, such as the correct mouse identification code to look for in the data reports, radio frequency, report rate between finger worn and operated base and receiver, report rate between the receiving unit and computer serial port. On power up, the MCU 237 first detects what type of interface 240 it is using to communicate with the computer, i.e. serial or PS/2. The MCU 237 then adapts according to which interface is found at 240. In serial mode, the voltage available on the RS-232 lines is regulated to 5 volts, in PS/2 mode this regulation is not necessary. The 5 volts are used to power the MCU 237. A second regulator is used to lower the voltage to 2.5 volts to power the whole receiving unit 26. Next, the MCU 237 configures the RF receiver with frequency information, RF receiving sensitivity selection, baud rate.

MCU 237 analyzes the received, demodulated data and discards all of the data reports which do not have the correct mouse identification code attached to them. In this mode, the MCU determines the correct identification code by latching onto the identification code in the first received report and comparing to the identification code stored in the EEPROM 260. The MCU 237 can then provide the appropriate signals to the host computer, such as a personal computer or workstation, through the PS/2 or serial host interface 240 and connector 242.

Two other functions of the computer receiving adapter are: (1) male miniature connector 226 available for the finger worn and operated device 21 to plug. The miniature connector including signals which used to change the configuration information of device 21. (2) to act as battery charger of device 21. The third function is when device 21 is plugged on computer receiving unit 26. the whole device can be used as a regular point device on table.

In the preferred embodiment, the data reports are transmitted at less than 9600 bits per second. The cursor movement [X, Y] is sent to receiving unit by standard mouse protocol in cable connected implementation. In RF wireless implementation, an eight bits identification code is set before the standard mouse data packets.

Referring to FIG. 3A is the algorithm flow diagram of MCU 213 in device 21. The flow diagram begins with standby block 401 wherein MCU 213 stop most of it's function and set RF transmitter 217 to standby mode while allowing peripheral I/O including ADC still functioning. Block 402 sampling the outputs [x, y, z] of sensor 27 less frequently. Once the sensor 27 is being touched, Block 403 enable the MCU 213 running at normal speed and the sensor output signals will be sampled consecutively as [x0, y0, z0] and [x1, y1, z1] at normal sample rate. [x0, y0, z0] and [x1, y1, z1] saved in internal register. Block 404 analysis whether sensor 27 is been touched by comparing z1 to a predefined threshold. If no touching at the second sample time, then Block 408 recognize it as one fingertip tapping and based on with next sample touching activity to identify which tapping gesture it is as illustrated in FIG. 3B. If the touching do happen at the second sample time, Block 407 dynamically adjusting the mapping sensitivity from relative fingertip movement to cursor movement. The cursor movement is proportional to the pressure applied between the two touched fingertips. For example, with the same relative fingertip movement, if lager pressure applied, the cursor moves faster; if the pressure smaller, the cursor will move slower. In short, more pressure will cause faster cursor movement. A pressure threshold setting P0 can be adjusted by configuration software according to user's preference. It is practical that the threshold pressure P0 may refer to a certain range instead of a single value. Block 407 mapping the fingertip movement to the cursor relative movement based on the following formula:

X1=z0/P0*(x1−x0)

Y1=z0/P0*(y1−y0)

Before next sample time, block 407 also replace the register content [x0, y0, z0] with latest sampled data [x1, y1, z1]. Block 410 sending the calculated cursor movement [X1,Y1] to RF transmitter or entering to block 402 to repeats to sample the touching signals at next time and repeats to calculate the cursor movement signal by the above formula or finger tapping gesture identification illustrated in FIG. 3B until no touching activity occurs. It is obvious that user can move cursor fast or large cursor displacement on the same small sensor area simply by increasing the touching pressure.

The finger worn and operated input device implements selection, execution, and drag functions to fully emulate mouse cursor control function. The selection, execution, and drag functions are implemented by emulating the generic click, double click, and click and drag functions performed by the left mouse button as defined in typical computer systems. FIG. 3B shows three finger tapping gestures which corresponding to above functions. Optionally, the selection, execution and drag functions can be simply implemented by mini press buttons sit near the sensor.

From the above description it can be seen that the device of the present invention is able to overcome the shortcomings of prior art devices by wearing the device on the thumb and operating by finger twiddle and finger tap gesture. The finger worn and operated device sensing the relative movement and tap gesture between thumb and index fingertip or middle fingertip. Processing and translating these sensing signal into cursor control signals and command signals.

The small size, ergonomic shape, natural finger operation and wireless communication form of the input device in the present invention extremely reduce RSI.

As can be appreciated from the foregoing, the wireless transmission of the signal from the transmitter in the mouse 21 to the computer receiving unit 26 eliminates most concerns about obstacles in the transmission path while at the same time permitting significantly improving the freedom for the user by eliminating any mechanical connection from the mouse 21 to the host computer. In addition, the identification code information and the ability to choose multiple transmission channels upon which to transmit avoids most concerns of radio interference with other devices in the environment.

Having fully described one embodiment of the present invention, it will be apparent to those of ordinary skill in the art that numerous alternatives and equivalents exist which do not depart from the invention set forth above. It is therefore to be understood that the invention is not to be limited by the foregoing description, but only by the appended claims.

While certain novel features of this invention have been shown and described and are pointed out in the annexed claims, it is not intended to be limited to the details above. Since it will be understood that various omissions, modifications, substitutions and changes in the forms and details of the device illustrated and in its operation can be made by those skilled in the art without departing in any way from the spirit of the present invention.

The forgoing description is considered as illustrative only of the principles of the invention. Furthermore, since numerous modifications and changes will readily occur to those skilled in the art. It is not desired to limit the invention to the exact operation and construction shown and described. And accordingly all suitable modifications and equivalents may be considered within the scope of the invention as defined by the claims below.

What is claimed is:

1. A method for providing finger movement and tap gesture input to a computer or instrument which allows a user to control the cursor movement on a display connected to computer or instrument, said method comprising:
touching thumb tip with index fingertip or any of the other three fingertips of the same hand by curling index finger or any of the other finger and thumb together and asserting pressure between the contacted said fingertips;
Twiddling said fingertip and thumb tip each other or just gliding said fingertip on said thumb tip;
sensing the relative movement and pressure between said fingertip and thumb tip with a two dimension position sensor in conjunction with another pressure sensor or a three dimension position sensor worn on said thumb tip;
mapping the said relative movement to said cursor movement based on said pressure or the third dimension variable from said three dimension sensor;
tapping said fingertip with said thumb tip to interactive with said display such as selection and executive command.
sensing the tapping gestures between said fingertip and thumb tip by said sensor.

2. A method according to claim 1, further comprising dynamically adjusting the mapping sensitivity from the relative movement between said fingertip and thumb tip to cursor movement on said display up or down based on said pressure between said touched finger tips or the third dimension variable related to said pressure so as to achieve both larger or fine cursor movement on the same sensing area.

3. The method as claimed in claim 1 and claim 2, further comprising:
tapping said fingertip on said thumb tip to act as mouse primary click
tapping said fingertip on said thumb tip twice quickly and with about the same pressure to provide computer a selection commands.
tapping said fingertip on said thumb tip twice quickly and moving fingertips to provide computer different command such as selecting and drag.

4. A method to wear point device sensor on finger and operated by finger to eliminate the need of the stationary support or handheld and to eliminate the tremor of hand of user, comprising:
a three dimension position sensor or two dimension sensor in conjunction with another pressure sensor, worn securely on said thumb with sensing area coincident to thumb tip and sensing area face out so as to permit said fingertip moving and taping on said sensor just like on said thumb fingerprint area;
said sensor to sense said relative movement in two orthogonal directions which determined by the sensor alignment and pressure between touched finger tips;
operating said sensor with index fingertip or middle fingertip by curling index finger or middle finger and thumb together. sensor signals considered as valid signals only when the said finger touched said sensor worn on said thumb so mistake signals or tremor can be eliminated.

5. A mobile finger worn and operated input device according to said method of claim 1, claim 2, claim 3 and claim 4 which allows a user to control the cursor movement on a display connected to computer, comprising finger worn and operated unit and computer receiving adapter unit,
wherein finger worn and operated unit, comprising:
a three dimension position sensor or two dimension sensor in conjunction with another pressure sensor, worn securely on said thumb tip with sensing area coincident to thumb tip to sense said relative movement in two orthogonal directions which determined by the sensor alignment and pressure between said fingertips; and
The said thumb worn base is made by electrical isolated material.
Wherein said thumb worn base means electrical insulated and has a barrel shaped configuration for said thumb to insert into it and a fastener or elastic base material to ensure no movement between said base and said thumb.
a microcontroller, for interpreting the signals from said sensor to the cursor movement and command signal of said display; and
a wireless transmitter for sending data to said computer over a wireless communication link; and
a battery to power the sensor and electronic components of the finger worn unit; and
antenna and small printed circuit board; and
a housing mounted on said thumb worn base to contain sensor processing circuit, microcontroller, RF transmitter, battery, antenna and small printed circuit board.
a computer receiving adapter unit connected to the mouse port or serial port of said computer via a cable or connector, for receiving and decoding signals from said wireless transmitter and sending the decoded signal to said computer to control cursor movement and selection command signals, wherein computer receiving adapter unit comprising radio frequency receiver, antenna, microcontroller, computer serial port interface circuit and connector with or without cable.

6. A computer peripheral input system comprises said finger worn and finger operated input device and a virtual keyboard on said screen operated by said input device.
